(19) United States
(12) Patent Application Publication
(10) Pub. No.: US 2022/0055036 A1
(43) Pub. Date: Feb. 24, 2022

(54) TRAY FOR PARALLEL PROCESSING OF MULTIPLE TEST DEVICES

(71) Applicant: BECTON DICKINSON AND COMPANY, Franklin Lakes, NJ (US)

(72) Inventor: Michael August Tycon, Scottsdale, AZ (US)

(73) Assignee: BECTON DICKINSON AND COMPANY, Franklin Lakes, NJ (US)

(21) Appl. No.: 17/405,115

(22) Filed: Aug. 18, 2021

Related U.S. Application Data
(60) Provisional application No. 63/067,515, filed on Aug. 19, 2020.

(51) Int. Cl. B01L 9/00

(52) U.S. Cl. CPC B01L 9/52; B01L 2300/027; B01L 2300/021

(57) ABSTRACT

A cartridge pre-processing device system and method receives immunoassay lateral flow assay test cartridges for development prior to submitting the cartridge for assay/analysis. The cartridge pre-processing device supports high assay throughput with reduced operator burden by automating device pre-processing timing steps without locking-down the reader that is used to perform the assay/analysis. The pre-processing device is operated in a walk-a-way mode. The pre-processing device is separate from the assay cartridge reader and is capable of automatically timing the development of an assay cartridge with minimal to no operator oversight. Additionally, the device disclosed herein is able to alert the operator when assay development is complete and when the assay has developed in excess of a predetermined flex-time associated with an individual cartridge.

### STATEMENT OF RELATED APPLICATIONS

The present application claims priority to U.S. Provisional Application No. 63/067,515, filed Aug. 19, 2020, the disclosure of which is incorporated by reference in its entirety.

### TECHNICAL FIELD

The present disclosure relates in general to batch processing trays of assay cartridges. Assay cartridges are widely used for point of care (POC) testing and laboratory testing. The collected patient sample is collected into an assay cartridge where end to end sample processing is completed. Sample processing is accomplished by, for example, lateral flow. The present disclosure relates to batch processing trays capable of processing multiple such assay test cartridges configured to detect varying analytes of interest in samples concurrently.

### BACKGROUND

Assay cartridges, such as lateral flow assay cartridges, are widely used for immunoassays. Lateral flow assays can quickly and accurately detect the presence or absence of, and in some cases quantify, an analyte of interest in a sample. Advantageously, lateral flow assays can be minimally invasive and used as point-of-care testing systems or for tests run in a laboratory.

Lateral flow devices are capable of receiving biological samples of a particular format (e.g., blood serum or plasma, urine, etc.). Typical acceptable samples are pre-processed between collection from the sample source (i.e. the patient) and application to the lateral flow device to remove or reduce the presence of confounding components, such as but not limited to components that obstruct the flow of sample through the device (e.g. red blood cells, white blood cells), components that interfere with detection of an analyte of interest in the device, and components that otherwise detract from accurately detecting an analyte of interest. In some cases, immunoassays include an assay membrane though which a fluid sample passes. The fluid sample carries objects of interest, such as analytes of interest, from a receiving zone to a detection or “test” zone downstream of the receiving zone.

In some cases, exposing the assay membrane to a raw fluid sample may result in clogging of the assay membrane, such that the fluid sample cannot flow through the assay membrane to the detection zone or movement of the fluid sample through the assay membrane to the detection zone is inhibited. This can result in very little or no analyte of interest flowing to the detection zone, leading to an inaccurate test result indicating that the fluid sample is “negative” for the analyte of interest or the analyte of interest is present at a concentration lower than the actual concentration. Lateral flow assay cartridges are described in WO2020033235A1, which is incorporated by reference herein.

To determine whether the sample is positive or negative, the assay cartridge is typically placed in some form of device reader or analyzer but can also be subjected to visual inspection. Typically, such readers are optical readers and include a light source and a light detector in communication with a data analyzer that can determine whether a sample is positive or negative for the immunoassay being performed. Examples of such immunoassays include assays for flu and other viruses such as COVID-19. One example of an analyzer is the BD (Becton Dickinson and Company) Veritor™ System. The Veritor™ instrument is a digital reader that processes lateral flow immunoassay test cartridges.

Veritor™ accommodates several different workflows to run an assay on a patient sample. The workflows typically require an assay incubation or development step followed by an assay reading step. A first possible workflow is a manual workflow in which a prepared sample is applied to the assay test cartridge and a timer (not integrated with the Veritor™ reader) is used to monitor the assay development for a prescribed time interval (e.g., 10 minutes). After the prescribed time interval has elapsed, the assay test cartridge is inserted into the reading instrument for analysis. This process can be applied to many test cartridges in rapid serial fashion, but this typically requires staggering the start of assay development such that the cartridges are ready for insertion into the instrument in rapid succession but at different times. This workflow increases throughput, but requires significant sample monitoring, increased lab-counter space, and additional lab timers.

An alternative workflow is an automated “walk-a-way” mode, in which a technician applies a prepared sample to an assay test cartridge and then inserts the cartridge into the reading instrument. The instrument times the assay development and automatically initiates analysis when that time window has elapsed. This workflow eases the operator burden, but ties up the instrument for the duration of the assay development, preventing batch processing. While suitable for very small clinics, this workflow prohibits the throughput needed for larger clinics or during peak testing season.

Improved workflows and apparatus in support of lateral flow immunoassay cartridge readers are therefore sought.

### BRIEF SUMMARY

The technology described herein provides devices, systems, and methods for facilitating assay test cartridge development and analysis. The device is a batch processing tray that enables high assay throughput that requires little to no monitoring or oversight by an operator or technician by automating the incubation or development of the cartridge (after the sample in the cartridge has been prepared for analysis) without locking-down a slot in a cartridge analyzer. The batch processing tray that supports this workflow is separate from the analyzer itself (e.g., the Veritor™). The batch processing tray contains a plurality of cartridge lanes so that the batch processing tray can simultaneously time the development of a plurality of cartridges. The batch processing tray can simultaneously process multiple cartridges even if the cartridges have different assay development times and/or different assay development start and end times.

An example of a prior art lateral flow device 100 is illustrated in FIG. 1. The device 100 includes a lateral flow test strip 200 received or housed within a cartridge 300. The cartridge 300 can include a top housing 304 coupled to a base housing 303. The housings 303, 304 can be formed of injection molded plastic, or any other suitable material. A buffer well 310, a sample well 320, and a read window 330 are defined in the top housing 304. A portion of test strip 200 is visible through the read window 330.

FIG. 2 illustrates the bottom of the lateral flow cartridge device 100 illustrated in FIG. 1. The cartridge 100 has a ribbed region 340 a bottom aperture 350 and a side aperture 360. The ribbed region 340 provides texture so that the cartridge does not slip when an operator handles the cartridge, such as when the cartridge is placed on or removed from a receptacle surface such as the tray surface. The side aperture 360 cooperates with a mechanism for engagement of the cartridge with the receptacle, allowing the cartridge to be secured in the tray or other receptacle. The mechanism cooperates with the side aperture 360 to secure and/or release the cartridge in the tray or other receptacle.

As noted above, cartridges are configured to perform a specific assay. Therefore, a cartridge configured to perform one assay (e.g., a flu assay) can have different pre-processing/development/incubation parameters than a cartridge configured to perform a different assay (e.g., a Covid-19 assay). For example, the cartridges configured to perform a flu assay may require an assay processing time that is different from the processing time required for a cartridge that will perform a Covid-19 assay. The batch processing tray automatically times the development of an assay cartridge upon the placement of the assay cartridge into a lane of the batch processing tray. The batch processing tray may then indicate when development is complete, including an indication of additional time that has elapsed beyond the allotted development time in an effort to prevent excessive assay development. The amount of additional time beyond the allotted development time is referred to as “flex time” herein.

The batch processing tray described herein supports a hybrid approach to the prior art methods described above. The batch processing tray automates the assay cartridge development/incubation and does not lock-down the cartridge reading instrument with cartridges that are not immediately ready to be read. The batch processing tray allows the technician/operator to walk away from that tray after assay cartridges have been placed in the lane of the batch processing tray. The batch processing tray can determine from the assay cartridge label the length of the incubation time for the individual cartridge placed in a receptacle. Multiple cartridges that are present in the batch processing tray at the same time may have the same incubation time or different incubation times. The incubation time for each cartridge is information carried by the cartridge label. That incubation time is read and associated with the lane (also referred to herein as cartridge receptacle) in which the cartridge is placed, Therefore, the length of time that a cartridge is resident in a lane depends on the incubation time associated with the particular cartridge. The batch processing tray indicates to the operator when the timed steps are complete, including an indication of time elapsed after the prescribed duration of assay cartridge development (flex-time), to prevent excessive assay development.

The batch processing tray improves the workflow for the incubation of cartridges such as lateral flow cartridges used in lateral flow assays. As noted above, in current workflows, the technician/operator needs to multi-task and devote significant time and counter-space to accommodate the incubation of multiple assay cartridges, when each cartridge may have a different start time, a different development/incubation time, and a different end time. Individual monitoring of each incubation time does not permit an operator to perform other tasks when monitoring the incubation of multiple cartridges with different incubation time windows simultaneously. Managing the incubation of multiple assay cartridges in the above manner increases the likelihood that assay cartridges may be over-incubated (i.e., the time between cartridge inoculation with sample and placing the cartridge in the reading instrument is too long). Managing the incubations of multiple cartridges in the above manner also increases the likelihood that assay cartridges may be under incubated (i.e., the time between assay cartridge inoculation with sample and placing the cartridge in the reading instrument is too short). When assay cartridges must be paired with individual timers to monitor incubation time, any mismatch or disruption in the cartridge/timer pairing can lead to a situation where the assay cartridge has not been incubated for the desired length of time. Such mismatches can lead to processing errors.

The batch processing tray described herein eliminates the need for individual timers to be paired with individual assay cartridges. Since the timer in the tray is automatically started when the assay cartridge is placed in a lane of the tray, operators have fewer steps to monitor, and may prepare additional assay samples in the interim. Also, the tray can detect the incubation time required for the individual cartridge, as such information is available on the barcode for the cartridge, which is read by the batch processing tray. Also, the tray is self-contained, reducing the footprint required to conduct batch testing.

Once the batch processing tray has determined that the incubation of the assay cartridge is complete and the assay cartridge can be provided to a reader, the batch processing tray provides an indication to the operator that the cartridge can be moved from the batch processing tray to a cartridge reader (e.g., Veritor™). This makes more efficient use of the reader, as the reader only receives cartridges that are ready to be read immediately. The reader is therefore not occupied by cartridges that are not ready to be read.

Described herein is a system for processing assay cartridges. The system has a base having a plurality of lanes. Each lane is sized to receive an assay cartridge. The base has a switch in each lane that is activated when a cartridge is placed in the lane. A timer is activated by the switch when the cartridge is placed in the lane. The base also has a reader that reads a code associated with the cartridge. The reader is in communication with a timer. The reader communicates a processing time to a timer for the lane in which the cartridge is placed. The base is also associated with an indicator that signals to a user at least a first and a second status of the processing cartridge. The first status is when the processing time has not elapsed and the second status is when the processing time has elapsed. Optionally, the lane has a latch that will engage a slot in the cartridge to secure the cartridge in the lane.

Optionally, the cartridge carries a label. The cartridge label carries information that can be read using a conventional reader. In one example, the cartridge label carries a bar code that carries the processing time and, optionally, other information about the cartridge (e.g., assay type, cartridge type, etc.). In this example the reader is a bar code reader. In another example the cartridge label is an RFID tag that carries the processing time and, optionally, other information about the cartridge (e.g., assay type, cartridge type, etc.).

Optionally, the switch in the base is an optical detector and the bar code reader is a camera. Optionally, the system has a processor with a memory. In those embodiments where the system has a processor, the processor is in communication with the reader, the switch and the timer, wherein the processor, based on code information for the cartridge, assigns a processing time to the lane in which the cartridge is placed and communicates the processing time to the timer. Optionally, the indicator conveys a signal to the user (i.e., the operator) when the processing time has elapsed. Optionally, the processor, based on the code information, communicates a flex-time to the timer associated with the lane in which the cartridge is placed, wherein the flex-time is associated with a third status of the cartridge. Optionally, the indicator conveys a signal to the user when the processing time has elapsed. Optionally the indicator is one of a signal light (one or more), an audible signal or a wireless signal communicated to a mobile device of the user. Optionally, the signal light with a first color indicates the first status of the cartridge and a second color to indicate the second status when the processing time has elapsed. The signal lights, in one embodiment, are LEDs. Optionally, the signal lights are a plurality of signal lights, each signal light emitting a color different than the other signal lights in the plurality of signal lights. In one manner of operation, the signal light is constant during the first status of the cartridge and blinks during the second cartridge status. Optionally, if the processor determines that the cartridge remains in the lane after the processing time has elapsed, the processor communicates to the indicator to provide an indication to the user that the cartridge has entered into the flex-time allocation. Optionally, if the processor detects the cartridge in the lane after the flex-time has elapsed, the processor communicates to the indicator to provide an error indication to the user.

### BRIEF DESCRIPTION OF DRAWINGS

The foregoing and other objects and advantages will be apparent upon consideration of the following detailed description, taken in conjunction with the accompanying drawings, in which like reference characters refer to like parts throughout, and in which:

FIG. 1 is a top plan view of a prior art lateral flow assay cartridge;

FIG. 2 is a bottom plan view of the prior art lateral flow cartridge of FIG. 1; and

FIG. 3A is a batch processing tray apparatus according to one embodiment;

FIG. 3B is a batch processing tray of FIG. 3A but with the cartridge lanes covered;

FIG. 4 illustrates one embodiment of a controller for the batch processing tray described herein.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

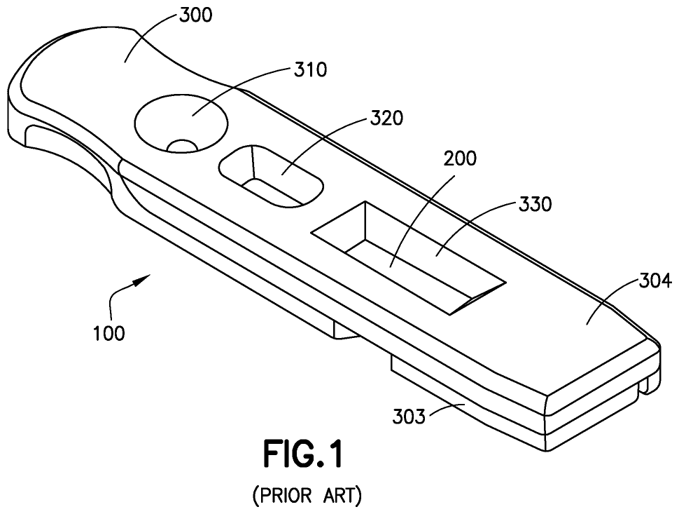

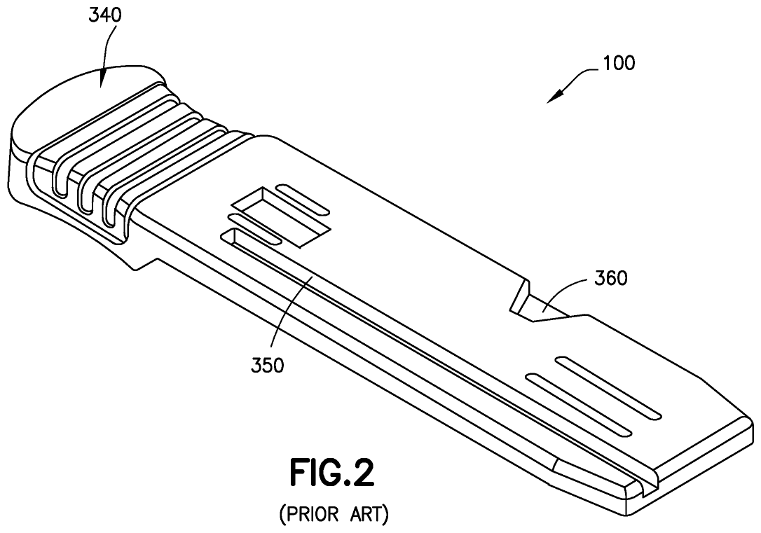

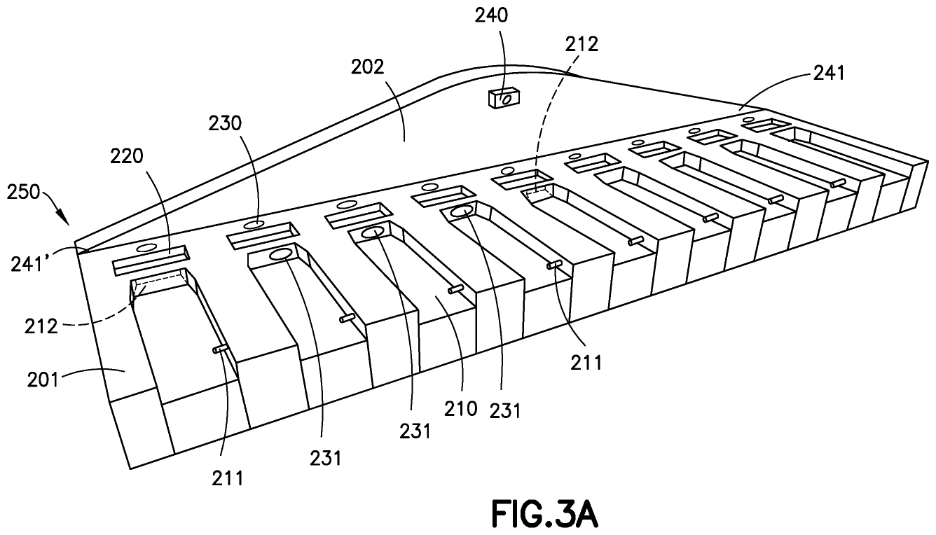

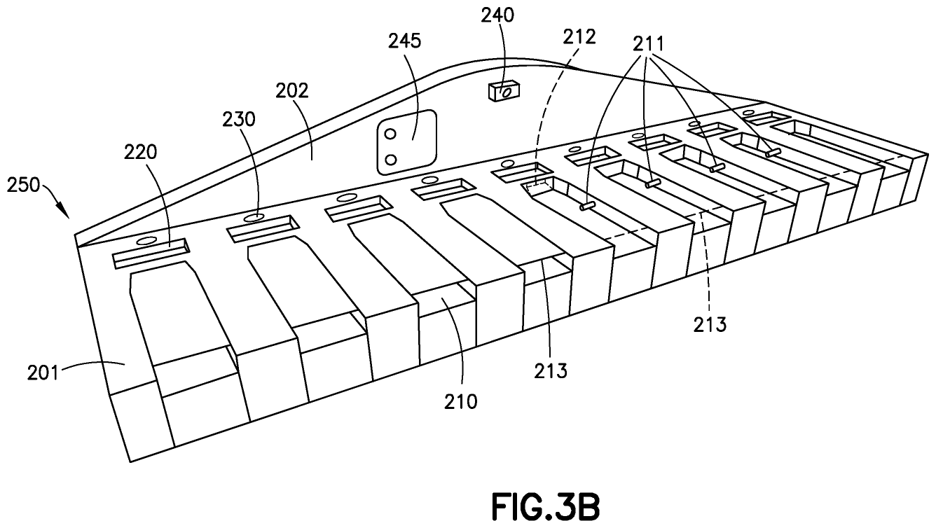

The disclosed batch processing tray may be configured to receive assay test cartridges as described in WO 2020/033235A1 which is incorporated by reference herein. The assay cartridge is illustrated in FIGS. 1 and 2 and the batch processing tray 250 is illustrated in FIGS. 3A and 3B.

The batch processing tray 250 as illustrated has a base 201, a raised back panel 202 and multiple lanes 210, each lane configured to receive a cartridge 100. The raised back panel 202 is located at the distal end of the lanes 210. The proximal end of the lanes 210 are open to facilitate cartridge insertion into and cartridge removal from the lanes 210. Optionally, the lanes 210 can be covered with cover 213 (FIG. 3B). The covers allow the cartridges to be incubated in an enclosed environment separated from ambient light. A portion of the covers 213 are illustrated in phantom in in order to view the lanes 210 covered thereby. The cartridge illustrated in FIG. 2 has a bottom topology to which the lanes conform to receive the cartridge. Since a cartridge is already configured to be inserted into a reader instrument, the lanes 210 can be configured in a like manner. For example, a reader instrument configured to receive the cartridge illustrated in FIG. 2 may have a spring mechanism that secures the cartridge 100 in the reader by setting into notch 360. The lanes 210 may have a similar mechanism, illustrated as a spring-loaded post 211 that will recess as the cartridge is inserted in the lane and then project into the notch 360 to secure the cartridge in the lane 210. Optionally, the lanes 210 have a recess 212 in the distal end in which the front portion of the cartridge is inserted. In another embodiment, the lanes 210 have a recess 212 (shown in phantom in one of lanes for purposes of illustration). In another embodiment, the lanes 210 are not recessed in the base and the distal end of the lanes have the recess 212 that receives the distal end of the cartridge.

The spring-loaded posts 211 can optionally be configured as a mechanical switch or a switch operated by machine vision. The switch can be placed anywhere in the cartridge lane 210 (i.e., the proximal end of the lane, the distal end of the lane, the bottom surface of the lane that supports the cartridge, or the sides of the lane). The switch is depressed when a cartridge is inserted into the lane 210. The spring-loaded posts 211 are not illustrated in all lanes, 210 but it is contemplated that, in those embodiments in which the lanes have spring-loaded posts, all lanes 210 will have a spring-loaded post therein.

The switch can also be an optical switch 231. The optical switch is triggered by inserting the cartridge into the lane 210. Machine vision can also be used to detect the presence of a cartridge in the lane 210. The optical switch 231 is illustrated in some lanes only for purposes of illustration. It is envisioned that, if such a switch is deployed it would be deployed in all lanes 210.

The batch processing tray 250 enables high assay throughput with minimal operator input by automating device timing steps without locking-down the reading instrument through walk-a-way mode. The batch processing tray is separate from the reading instrument.

As noted above, each cartridge performs a single assay but assay cartridges can be configured to perform different assays. A cartridge configured to perform a certain assay is referred to as an assay cartridge type herein. Each type of assay cartridge has a specific incubation time interval particular to the type of assay (i.e., a Flu assay). Once seated in a lane, a switch 231 is activated. This registers the placement of a cartridge in a particular lane. This also activates a timer 220 to automatically time the development of an assay cartridge upon the placement of a cartridge into the tray. Such timers are well known to one skilled in the art and not described in detail herein. The batch processing tray 250 has a status light 230 that indicates when development is complete (i.e., changing color from red to green). The status lights 230 are for each lane 210. The timer 220 includes a timer display that displays the time that has elapsed (the timer can also be a countdown timer which shows the time remaining). The timer 220 is configured to display the amount of time that has elapsed after the cartridge has reached the full development time. The time that the cartridge can “sit” after incubation but before it is read is referred to as flex-time herein. The flex-time is the amount of flexibility the operator has in delivering a developed cartridge to a reader instrument. If the assay cartridge is not delivered to the cartridge reader within this time window, the assay will be overdeveloped and the test results will not be reliable.

In one embodiment, the batch processing tray 250 is configured to receive one type of assay cartridge. The batch processing tray can receive a plurality of cartridges, in side-by-side lanes 210. Insertion of a cartridge into one of the plurality of cartridge lanes depresses the switch (i.e., mechanical, optical), automatically starting a countdown timer 220 configured for the development of a particular type of assay. In one embodiment, the countdown first goes to zero. When the timer reaches zero, the timer can indicate the time elapsed after the prescribed incubation time has elapsed (i.e., the flex-time). The timer can be programmed manually by the operator or the timer can be programmed automatically from coded information associated with the cartridge that prescribes the incubation time for the particular cartridge. The cartridge can carry such information in a machine-readable tag or label associated with the cartridge. The programming of such labels/tags to carry such information or access to such information is well known to one skilled in the art and not described in detail herein.

Any conventional display is suitable for the timer display 220. Such digital timer displays are well known to one skilled in the art and are not described in detail herein. For example, the timer display can be a liquid crystal display (LCD) disposed in a lane of the batch processing tray.

In the illustrated embodiment of FIG. 3A, the batch processing tray indicates when the assay development time has elapsed. In the illustrated embodiment each lane 210 is provided with a status light 230. The status light can be any conventional indicator and it may switch from “off” to “on” when development is complete or change color, or provide some other indication. In one embodiment the status light is a light emitting diode (LED). However, any conventional indicator is contemplated. In alternative embodiments, the indicator is an audible indicator or any other conventional indicator for conveying to the operator that the assay incubation time has elapsed. In one embodiment the status light can flash or blink during development, and then hold steady after an assay is fully developed and ready to be removed from the batch processing tray and placed in the reader. In one example the status light could be on constantly during development/incubation, blinking during flex-time, and off when the flex-time has been exceeded. Multicolor LEDs or other lights can provide similar indications. In other embodiments, if the flex-time elapses and the cartridge remain in the lane after the flex-time has elapsed, the status light 230 can indicate “user error.” Other status light configurations are contemplated beyond single status lights.

In a second embodiment, the batch processing tray is configured to receive a second type of assay cartridge. In such an embodiment, the batch processing tray is programmed to time the development of first and second assay type each with its specific development time and flex-time. The development time and the flex-time can be the same or different. The batch processing tray is provided with a sensor 240 (e.g., a camera) mounted thereon to detect a label (e.g., a barcode label, an RFID tag, etc.) disposed on each assay cartridge identifying the type of assay and allowing the batch processing tray to begin the development countdown corresponding to the detected assay type. The camera can also be used to detect the information on the cartridge label or tag (e.g., the assay type) and that information can be transmitted to a controller/processor that will then determine the incubation time and the flex-time for the assay cartridge. Alternatively, the operator could manually input the assay type or countdown interval by way of, for example, an interface 245 used to select an “assay mode.” The position of the interface is for illustrative purposes only. The interface can be attached to the base physically or communicate wirelessly with the base. The interface can be a touch screen, or have dials or buttons or any other type of switch to interface with the user. In other embodiments, each lane has its own interface. In other embodiments, the batch processing tray could be configured to receive additional types of assay cartridges.

Additionally, the batch processing tray 250 may contain ethernet or wireless capabilities, enabling the batch processing tray to be remotely updated. Such capabilities would enable the tray to handle assay cartridges for new assay types as the assay reader menu is expanded over time. Moreover, the batch processing tray can optionally be coupled to a smart-device application (app), alerting an operator to assay cartridge status information from the batch processing tray. The batch processing tray can optionally be equipped with a wireless/Bluetooth transmitter configured to communicate the assay cartridge status information to the operator. Such capability further reduces the need for the operator to return and check in on the status of the cartridges in the base station to confirm whether or not the incubation time, the flex-time, or both, have elapsed.

Referring to FIG. 3A, the camera 240 is positioned so that it can sense and image all of the lanes 210. The camera 240 can be angled downwards from its position to include all lanes 210 in its field of view. Optionally, the camera 240 can project outward from raised back panel 202 and be aimed downward to include all lanes 210 in its field of view. In another aspect, the camera 240 can project from raised back panel 202 at either end 241, 241′ of the back panel 240 and include all lanes 210 of the batch processing tray 250. In yet another embodiment, each lane 210 has its own camera 240. In yet another embodiment, the camera 240 is configured as a bar code reader and the operator can scan the barcode on the label of the cartridge 100 before being placed in a lane 210 of the batch processing tray 250. In yet other embodiments, the camera has its own support and is not supported by raised back panel 202. Raised back panel 202 is itself an optional feature of the batch processing unit 250. In other embodiments, the reader is an RFID reader that is either integrated with or separate from the camera.

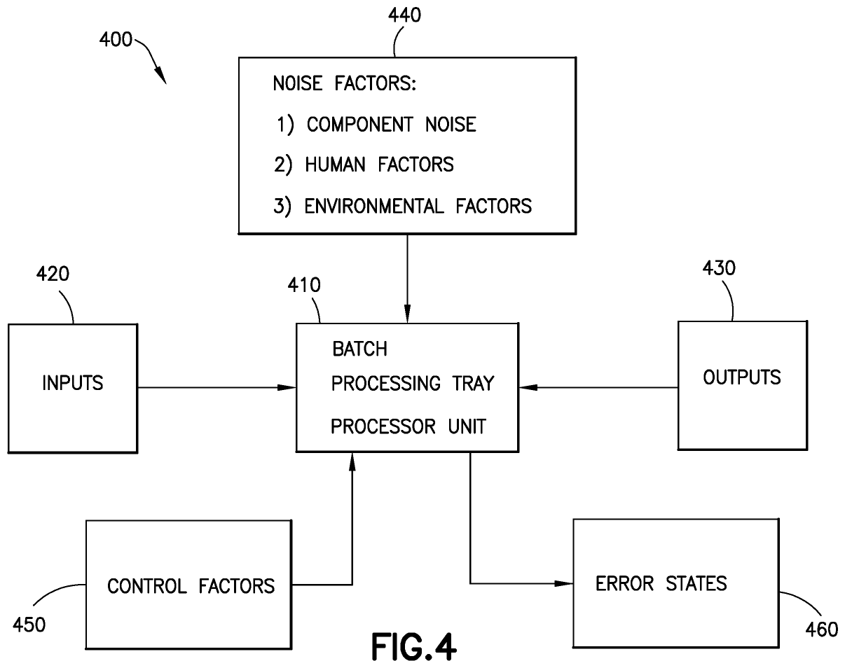

FIG. 4 illustrates one example of the manner in which the operation of the batch processing tray is controlled. The controller 400 includes the batch processing tray processor unit 410. Inputs 420 into the batch processor unit include, but are not limited to: 1) the type of assay cartridge; 2) the activation of the cartridge switch when the cartridge is inserted into the cartridge lane; 3) the code information associated with the cartridge; 4) the information regarding the assay time (e.g., incubation time, flex-time, etc.); and 5) operator contact method (e.g., blue tooth device, wireless device, audible alert, visual alert, etc.). Outputs 430 from the processor unit 410 include, but are not limited to: 1) confirmation that the assay cartridge bar code information has been successfully read; 2) the assay incubation/development time window; 3) the assay flex-time time window; 4) the countdown indicator for incubation/development times and flex-times; 5) the indicators for assay completion time; 6) indicators for assay expiration time (i.e. timer in excess of incubation/development time and flex-time); and 7) operator notifications regarding output indications.

The processor unit is configured to address and indicate certain errors or noise factors 440. Component noise that can adversely affect the operation of the batch processing tray include, but are not limited to: 1) bar code not successfully read; 2) cartridge is structurally defective and will not seat in lane; and 3) the switch or camera does not provide indicia that cartridge is placed in lane. Operator errors can also be detected by the processor. Such errors include improper placement of a cartridge in a lane; cartridge removed prior to completion of incubation/development countdown; and 3) operator contact information is not found. Environmental conditions that may adversely affect assay development can also be detected and used by the processor. For example, if the light level in the laboratory is in excess of what can accommodate successful processing, that information can be used by the processor to output a processing error. Detection of temperature and humidity that is outside the range of conditions for suitable assay cartridge incubation and development can also trigger an indication that the incubation/development of the cartridge was not successful.

The processor also receives a number of control factors 450, examples of which include: 1) the number of cartridge lanes in the batch process tray; 2) the positioning of the field of view of the camera/bar code reader; 3) the display information (e.g. text); 4) the indicator light configuration (e.g. the colors of the lights or the condition of the illumination (i.e., off, on, blinking etc.) and the indicia associated with each configuration; 5) the processor received instruction on how the assay information is to be updated; 6) the processor is programmed on what assays the batch processing tray is configured to support; and 7) communication protocols (e.g. wireless, blue tooth, etc.).

The processor is configured to output certain error states 460 including, but not limited to: 1) cartridges improperly inserted; 2) barcode not successfully read; 3) lane timer malfunction (e.g., early time out); 4) premature removal of cartridge from the lane (i.e., removal before the timer times out); and 5) wireless connection not detected.

The batch processing tray as described herein supports many different workflows. In one embodiment, the workflow commences with an operator or technician inoculating an assay cartridge with a patient sample. The inoculated cartridge is inserted into a lane of the batch processing unit. If there are empty lanes, the operator can decide if additional cartridges should be inoculated and inserted into the tray. Once the cartridge is inserted, the switch is activated and the camera obtains barcode information from the inserted assay cartridge. The camera transmits this information to the controller and the controller assigns a development/incubation time and flex-time to that lane. If the processor does not recognize the bar code information, the processor causes an invalid indication vis-à-vis lights associated with the lane in which the cartridge carrying the unreadable or unrecognized bar code information is inserted. The unit stops processing the cartridge in that lane. Optionally, the operator updates the processing information with the information about the aborted processing of the specific cartridge.

If the processor recognizes the bar code information, the timer for the lane is activated. The display can simply indicate processing or can provide a countdown timer to completion. Once the time for incubation/development has elapsed, the display can either simply indicate that incubation/development is complete or a flex-time countdown timer can be activated. Optionally, the control unit can cause the processor to notify the operator via wireless communication that development time is completed.

At this point the operator can remove the cartridge from the lane and insert the cartridge into a reader. If the operator does not remove the cartridge, the flex-time timer starts. If the operator does remove the cartridge at this point, the lane timer turns off and processing for that lane stops. Other lanes continue to process as normal. If the operator removes the cartridge before flex-time countdown, the lane timer turns off and processing for that lane stops. If the cartridge is not removed when the flex-time counts down, that information is provided to the controller and the controller can cause either the timer or the status indicator for that lane to indicate an expired cartridge. Optionally, the controller can cause the processor to communicate to the operator that an assay has expired. Once the user removes the cartridge, processing for that lane terminates.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A system for processing assay cartridges, the system comprising:
a base comprising a plurality of lanes, each lane sized to receive an assay cartridge, the base further comprising:
a switch that is activated when a cartridge is placed in the lane;
a timer that is activated by the switch when the cartridge is placed in the lane;
a reader that reads a code associated with the cartridge, the code reader in communication with a timer, wherein the code reader communicates a processing time to a timer associated with the lane in which the cartridge is received; and
an indicator that signals to a user at least a first and a second status of the processing cartridge wherein the first status is when the processing time has not elapsed and the second status is when the processing time has elapsed.

2. The system of claim 1 further comprising a latch that will engage a slot in the cartridge to secure the cartridge in the lane.

3. The system of claim 1 wherein the switch is selected from the group consisting of an optical switch and a mechanical switch.

4. The system of claim 3 wherein the switch is operated by a reader that detects placement of the cartridge in the lane.

5. The system of claim 1 wherein the code reader is a camera.

6. The system of claim 1 further comprising a processor comprising a memory.

7. The system of claim 6 wherein the processor is in communication with the code reader, the switch and the timer, wherein the processor, based on code information for the cartridge assigns a processing time to the lane in which the cartridge is placed and communicates the processing time to the timer.

8. The system of claim 7 wherein the indicator conveys a signal to the user when the processing time has elapsed.

9. The system of claim 7 wherein the processor, based on the code information, communicates a flex-time to the timer associated with the lane in which the cartridge is placed, wherein the flex-time is associated with a third status of the cartridge.

10. The system of claim 9 wherein the indicator conveys a signal to the user when the processing time has elapsed.

11. The system of claim 8 wherein the indicator is at least one of signal lights, an audible signal, or a wireless signal.

12. The system of claim 11 wherein the indicator is a signal light with a first color indicates the first status of the processing cartridge and a second color to indicate the second status of the processing cartridge.

13. The system of claim 12 wherein the signal light is an LED.

14. The system of claim 12 wherein the signal light is a plurality of signal lights, each signal light emitting a color different than the other signal lights in the plurality of signal lights.

15. The system of claim 11 wherein the indicator is a signal light that is constant during the first status of the processing cartridge and blinks during the second status of the processing cartridge.

16. The system of claim 7 wherein, if the processor determines that the processing cartridge remains in the lane after the processing time has elapsed, the processor communicates to the indicator to provide an error indication to the user.

17. The system of claim 9 wherein, if the processor determines that the cartridge remains in the lane after the flex-time has elapsed, the processor communicates to the indicator to provide an error indication to the user.

18. The system of claim 6 wherein the cartridge is labeled with a bar code and the reader is a bar code reader.

19. The system of claim 6 wherein the cartridge is associated with an RFID tag and the reader is an RFID reader.

20. The system of claim 11 wherein the indicator communicates a signal to a mobile device.

21. The system of claim 12 wherein the processor, based on the code information, communicates a flex-time to the timer associated with the lane in which the cartridge is placed, wherein the flex-time is associated with a third status of the cartridge, and wherein the signal light has a third color to indicate the third status.

22. The system of claim 21 wherein the cartridge is labeled with a bar code and the reader is a bar code reader.

23. The system of claim 21 wherein the cartridge is associated with an RFID tag and the reader is an RFID reader.
